(19) United States
(12) Patent Application Publication
(10) Pub. No.: US 2025/0315833 A1
(43) Pub. Date: Oct. 9, 2025

(54) SYSTEM AND METHOD OF AUTHORIZING AND PERFORMING PAYMENT TRANSACTIONS

(71) Applicant: Olga VENCHEVA, Mississauga (CA)

(72) Inventor: Olga VENCHEVA, Mississauga (CA)

(21) Appl. No.: 18/626,363

(22) Filed: Apr. 4, 2024

(51) Int. Cl. G06Q 20/40

(52) U.S. Cl. CPC G06Q 20/4015; G06Q 20/40145

(57) ABSTRACT

The present invention relates generally to the technological field of payment systems. More specifically, the present invention relates to technical solutions for performing payment transactions from inside a vehicle, also known as in-cart payment systems (ICPS). The claimed invention represents the system and method of authorizing and performing payment transactions, which provide an improvement of the technological field of payment systems by increasing security of in-vehicle payments, while maintaining the procedure easy and convenient to the consumer, in particular, by requiring consumer interaction with in-vehicle computer only.

### FIELD OF THE INVENTION

The present invention relates generally to the technological field of payment systems. More specifically, the present invention relates to technical solutions for performing payment transactions while staying inside a vehicle, also known as in-car payment systems (ICPS).

### BACKGROUND OF THE INVENTION

Nowadays, the rapid development of information technologies has led to the ubiquitous usage of mobile payments. Currently deployed technical solutions helped to increase both security of confidential information (e.g., payment credentials, authentication data etc.) as well as simplicity and convenience of use.

Consumers often face a situation when they need to make purchases, while being in a vehicle (e.g., a car). Such purchases may include, e.g., paying for a parking lot, ordering, and buying food in a drive-thru café, purchasing gas at a gas station or electrical charging at a charging unit, etc. There are many technical solutions for performing such payments known in the art to date.

The most common way requires a consumer to lean out the vehicle window, or to go out of the vehicle, and to conduct payment using a Point-Of-Sale (POS) terminal and personal payment device (e.g., a plastic payment card or smartphone). A POS-terminal may be installed, e.g., on a charging or gas unit of a gas station, near the parking entrance or as a part of a self-service payment and information terminal outside the café. It may be further equipped with a touchscreen for selecting and ordering products via a user interface. Said solution is advantageous in respect of security, since reference authentication data (e.g., a reference value of a password or PIN, or reference value of cardholder's biometric data), as well as cardholder's payment credentials, are securely stored in the memory of personal payment device (e.g., using embedded secure element (eSE)). In most cases, authentication of payment transaction is done by comparing reference authentication data and input authentication data, entered by the cardholder (e.g., a PIN, fingerprint scan, or image of cardholder's face) by means of the personal payment device itself, without transferring confidential data to other nodes. The main drawback of such a solution lies in that the consumer needs to get out of the vehicle in order to make a payment, which is inconvenient. Furthermore, in view of the fact that, nowadays, most cars are equipped with in-car computers having large multimedia screens, the necessity of using other devices instead (e.g., smartphone and POS-terminal) while being inside a vehicle, is clearly irrational and disadvantageous.

With the development of in-car computing devices in the last years, a new solution has arisen. The idea of such a solution is to transfer payment functionality into the in-car computing device completely. Accordingly, the consumer become able to pay for various goods and services (e.g., ordering and paying for coffee at the coffee shop nearby, buying gas or paying for a parking lot) via designated software application, without using neither his personal payment device nor POS-terminal, installed at the point of sale, i.e., using only in-car computing device.

The obvious advantage of this solution is in providing easy and convenient purchasing process consumer-wise. Nevertheless, this solution requires storing both cardholder's reference authentication data and payment credentials (e.g., details about consumer's account) either in the memory of the in-car computing device or at the remote server. Both options may be considered disadvantageous, because the same sensitive data is stored in consumer's mobile device already, and having additional copies of it stored in other devices increases vulnerability of the payment system to cyber-attacks. Moreover, this security issue gets even stronger when this solution is applied not in the personal vehicle, but, e.g., in a rented one.

Also, there are solutions where the in-car payment is solely performed via a consumer's mobile device, i.e., without interaction with an in-car computing device and POS-terminal. Such solutions are usually performed by a designated software application installed on the mobile device, e.g., application of a specific gas station chain.

Such solutions are advantageously simple since only a single device out of mentioned three ones is involved, and secure since all confidential data is not shared between other devices. Cardholder's authentication (usually biometric) is also performed by mobile device locally and is therefore secure. The disadvantage of this solution is the same as for the first provided example—the necessity of using a mobile device instead of an in-car computer, which is designated to be used when sitting in the car.

### SUMMARY OF THE INVENTION

Accordingly, there is a need for a system and method of authorizing and performing payment transactions, which would provide an improvement of the technological field of payment systems by increasing security of in-vehicle payments, while maintaining the procedure easy and convenient to the consumer, in particular, by requiring consumer interaction with in-vehicle computer only.

In the general aspect, the invention may be directed to a method of authorizing payment transactions, by at least one processor. The method of authorizing payment transactions may include acknowledging a proximity of a first computing device associated with a vehicle to a second computing device associated with a point of sale; transferring, from the second computing device to the first computing device, a request to authorize the payment transaction, upon acknowledging the proximity; transferring, from the first computing device to a third computing device associated with a cardholder, a request to receive a reference authentication data element, upon receiving the request to authorize the payment transaction; transferring, from the third computing device to the first computing device, the reference authentication data element, in response to the request to receive the reference authentication data element; receiving, via an input module of the first computing device, an input authentication data element, entered by the cardholder; determining a similarity metric value, representing a degree of similarity between the reference authentication data element and the input authentication data element; and authorizing a payment transaction, based on the similarity metric value.

In another general aspect, the invention may be directed to a method of performing payment transactions, by at least one processor. Said method of performing payment transactions may include acknowledging a proximity of a first computing device associated with a vehicle to a second computing device associated with a point of sale; transferring, from the second computing device to the first computing device, a request to authorize the payment transaction, upon acknowledging the proximity; transferring, from the first computing device to a third computing device associated with a cardholder, a request to receive a reference authentication data element, upon receiving the request to authorize the payment transaction; transferring, from the third computing device to the first computing device, the reference authentication data element, in response to the request to receive the reference authentication data element; receiving, via an input module of the first computing device, an input authentication data element, entered by the cardholder; determining a similarity metric value, representing a degree of similarity between the reference authentication data element and the input authentication data element; authorizing a payment transaction, based on the similarity metric value; and settling the payment transaction, provided that the payment transaction is authorized.

In yet another general aspect, the present invention may be directed to a system for performing payment transactions. The system may include a non-transitory memory device, wherein modules of instruction code are stored, and at least one processor associated with the memory device, and configured to execute the modules of instruction code. Upon execution of said modules of instruction code, the at least one processor may be configured to acknowledge a proximity of a first computing device associated with a vehicle to a second computing device associated with a point of sale; transfer, from the second computing device to the first computing device, a request to authorize the payment transaction, upon acknowledging the proximity; transfer, from the first computing device to a third computing device associated with a cardholder, a request to receive a reference authentication data element, upon receiving the request to authorize the payment transaction; transfer, from the third computing device to the first computing device, the reference authentication data element, in response to the request to receive the reference authentication data element; receive, via an input module of the first computing device, an input authentication data element, entered by the cardholder; determine a similarity metric value, representing a degree of similarity between the reference authentication data element and the input authentication data element; authorize a payment transaction, based on the similarity metric value; and settle the payment transaction, provided that the payment transaction is authorized.

In some embodiments, the input module may include a biometric data capturing module, and the reference authentication data element and the input authentication data element may represent biometric data of the cardholder.

In some embodiments, the biometric data capturing module may include a camera; and the reference authentication data element and the input authentication data element may include an image of a cardholder's face.

In some embodiments, the biometric data capturing module may include a fingerprint scanner; and the reference authentication data element and the input authentication data element may include a scan of a cardholder's fingerprint.

In some embodiments, the input module may include a touchscreen configured to represent a virtual keyboard; and the reference authentication data element and the input authentication data element may include a numeric or alphanumeric code.

In some embodiments, acknowledging the proximity of the first computing device to the second computing device may include the following: establishing a first wireless connection between the first computing device and the second computing device; determining a value of at least one parameter of the first wireless connection; and acknowledging the proximity of the first computing device to the second computing device, provided that the value of the at least one parameter surpasses a predefined threshold value of the at least one parameter.

In some embodiments, the second computing device may include an antenna array and the at least one parameter of the first wireless connection may be selected from a list consisting of: (i) signal strength; (ii) Angle of Arrival (AoA); (iii) Angle of Departure (AoD); and (iv) Time-of-Flight (ToF).

In some embodiments, the method of authorizing payment transactions may further include establishing a second wireless connection between the first computing device and the second computing device, provided that the proximity is acknowledged; wherein said transferring, from the second computing device to the first computing device, of the request to authorize the payment transaction, is performed via the second wireless connection. The method of authorizing payment transactions may further include transferring, from the first computing device to the second computing device via the second wireless connection, an authorization confirmation data element, confirming that the payment transaction has been authorized.

In some embodiments, the first wireless connection and/or the second wireless connection is performed via a wireless communication protocol selected from a list consisting of: (i) Bluetooth Low Energy (BLE); (ii) Ultra-wideband (UWB); (iii) Wi-Fi; (iv) RFID; and (v) NFC.

In some embodiments, acknowledging the proximity of the first computing device to the second computing device may include determining a geolocation of the first computing device via Global Positioning System (GPS); estimating distance from the geolocation of the first computing device to a geolocation of the second computing device; acknowledging the proximity of the first computing device to the second computing device, based on the estimated distance.

In some embodiments, authorizing a payment transaction, based on the similarity metric value, may include authorizing a payment transaction, provided that the similarity metric value surpasses a predefined similarity metric threshold value.

In some embodiments, the method of performing payment transactions may further include, transferring, from the second computing device to the first computing device, request to receive payment credentials of the cardholder; and transferring, from the first computing device to the second computing device, payment credentials of the cardholder, in response to the request to receive the payment credentials of the cardholder, provided that the payment transaction is authorized. Settling the payment transaction may be performed by the second computing device, using the payment credentials of the cardholder.

In some embodiments, the method of performing payment transactions may further include retransferring, from the first computing device to the third computing device, a request to receive the payment credentials of the cardholder; transferring, from the third computing device to the first computing device, the payment credentials of the cardholder, in response to the request to receive the payment credentials of the cardholder.

In some embodiments, the method of performing payment transactions may further include transferring, from the first computing device to the third computing device, a request to receive the payment credentials of the cardholder; and transferring, from the third computing device to the first computing device, the payment credentials of the cardholder, in response to the request to receive the payment credentials of the cardholder. Settling the payment transaction may be performed by the first computing device, using the payment credentials of the cardholder.

In some embodiments, the method of performing payment transactions may further include transferring from the second computing device to the first computing device, a seller payment data element, which includes at least one of the following: (a) a payment credentials of a seller; (b) a Uniform Resource Identifier (URI) link to a payment service of a seller. Settling the payment transaction may be further performed using the seller payment data element.

In some embodiments, the method of performing payment transactions may further include providing, via a user interface (UI) of the first computing device, UI selection data elements, corresponding to optional parameters to be selected by the cardholder; and receiving, via the UI of the first computing device, an input selection data element, entered by the cardholder, representing selection of at least one of said UI selection data elements. Settling the payment transaction may be further performed based on the input selection data element.

In some embodiments, the method of performing payment transactions may further include transferring, from the second computing device to the first computing device, an option selection data element, representing said optional parameters. Providing, via the UI of the first computing device, UI selection data elements, may be performed based on the option selection data element.

In some embodiments, the payment credentials of the cardholder or the payment credentials of the seller may include at least one of the following: (a) a Primary Account Number (PAN) of the cardholder or the seller accordingly, (b) a payment token of the cardholder or the seller accordingly.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a concept of the present invention, according to some embodiments;

FIG. 2 is a block diagram, depicting a computing device which may be included in a system for performing payment transactions, according to some embodiments;

FIG. 3A is a block diagram, depicting general hardware aspects of a system for performing payment transaction, according to some embodiments;

FIG. 3B is a block diagram, depicting software aspects of a system for performing payment transaction, according to some embodiments;

FIG. 4 is a sequence diagram, depicting performance of a payment transaction by the system for performing payment transactions, according to some embodiments;

FIG. 5 is a flow diagram, depicting a method of authorizing payment transactions, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “choosing”, “selecting”, “omitting”, “training” or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

It shall be understood that, in the present description, the terms “user”, “cardholder”, “consumer”, and “driver” may be used interchangeably.

It shall be understood that, in the present description, the terms “car” and “vehicle” may be used interchangeably, same as “in-car computing device”, “in-vehicle computing device”, “computing device associated with a vehicle” and “computing device associated with a car”.

Unless explicitly stated, the method embodiments described herein are not constrained to a particular order or sequence. Additionally, some of the described method embodiments or elements thereof can occur or be performed simultaneously, at the same point in time, concurrently, or iteratively and repeatedly.

In embodiments of the present invention, some steps of the claimed method (e.g., determining the similarity metric value, when performing authorization using biometric data of a cardholder) may be performed using machine-learning (ML)-based models. ML-based models may be configured or “trained” for a specific task, e.g., classification or regression.

In some embodiments, ML-based models may be artificial neural networks (ANN).

A neural network (NN) or an artificial neural network (ANN), e.g., a neural network implementing a machine learning (ML) or artificial intelligence (AI) function, may refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. A processor, e.g., CPUs or graphics processing units (GPUs), or a dedicated hardware device may perform the relevant calculations.

It should be obvious for the one ordinarily skilled in the art that various ML-based models can be implemented without departing from the essence of the present invention. It should also be understood, that in some embodiments ML-based model may be a single ML-based model or a set (ensemble) of ML-based models realizing as a whole the same function as a single one. Hence, in view of the scope of the present invention, the abovementioned variants should be considered equivalent.

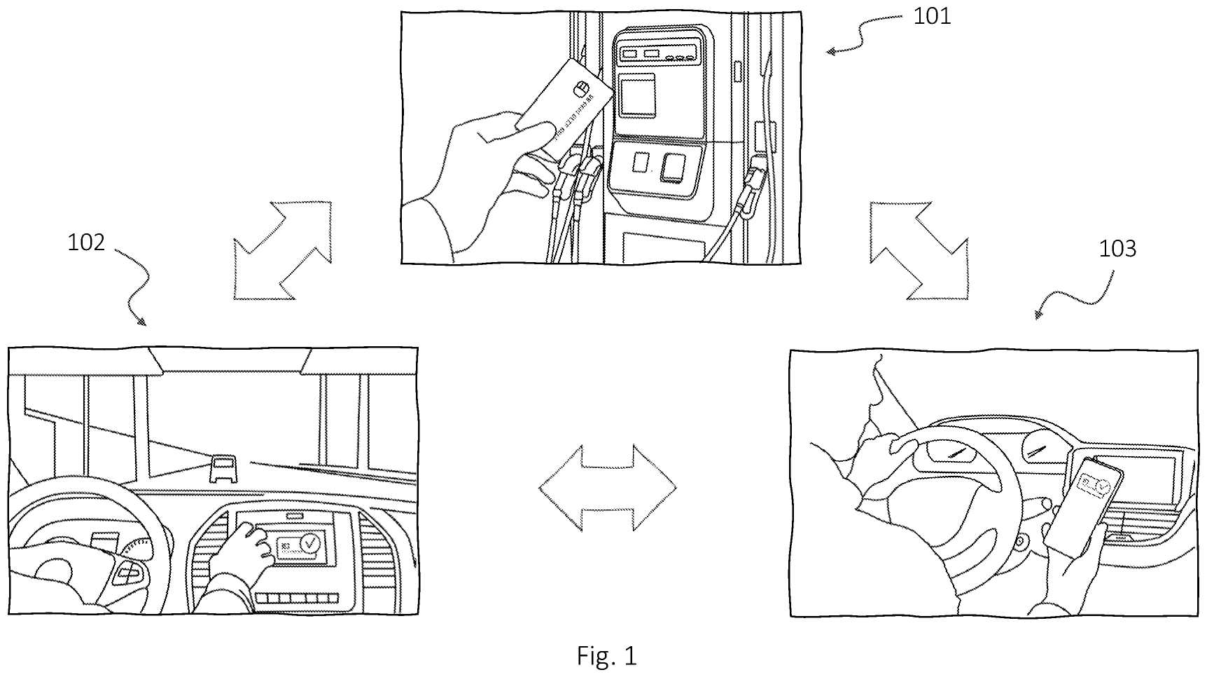

### FIG. 1—The Concept

Reference is now made to FIG. 1, depicting a schematic representation of a concept of the present invention, according to some embodiments.

As indicated above, the solutions of in-vehicle payments known in the art may be divided into three main groups: (i) the first group 101 represents the ones requiring direct consumer interaction with POS terminal 101′, paying by using plastic card or e-wallet of cardholder's mobile device; (ii) the second group 102 represents the ones wherein the payment transaction is made using in-vehicle computing device only (i.e., not using the cardholder's mobile device or POS-terminal); and (iii) the third group 103 represents the ones, wherein payment transaction is performed using cardholder's mobile device only (i.e., not using in-vehicle computing device and/or POS-terminal).

The present invention effectively incorporates beneficial aspects of the known solutions of groups 101, 102, and 103, and provides for achievement of a synergistic effect by this incorporation.

Firstly, same as solution 101, it represents a proximity-based payment procedure, e.g., a procedure wherein the proximity to the POS-terminal is evaluated. Such solutions, in most cases, provide for much easier human-computer interaction, since it helps to omit redundant and often erroneous actions. E.g., in solutions which are not proximity-based, the user needs to search for a specific point of sale, or approve a choice suggested by a computing device (e.g., in-car computing device). Another important advantage of the proximity-based approach, as it is elaborated in the claimed invention, lies in that the acknowledgement of proximity of an in-car computing device to the point of sale acts as an additional condition (or factor) to be met in order to start transferring confidential data (e.g., transferring reference authentication data element (cardholder's biometric data, password, payment credentials etc.)) to the in-car computing device. In such a configuration, most of the time such essential information is securely kept within the memory of the cardholder's mobile device and is transferred to the in-car computing device only when said proximity condition is met.

Moreover, the proximity condition, as a step of payment transaction authorization procedure, has yet another important advantage. This advantage lies in the fact that proximity acknowledgement can only appear because of a specific user-initiated action-a decision to direct the car towards a specific point of sale. Such an action by itself confirms the user's confidence in that the specific point of sale is a trusted one, and his intention to make a purchase therewith. Thus, the abovementioned aspects contribute to the improvement of in-vehicle payment security.

Secondly, same as solution 102, the claimed invention represents a solution that, from the consumer's perspective, involves user interaction only with an in-car computer. Obviously, it helps to maintain the procedure easy and convenient to the user, since he does not need to switch between different devices in order to make a purchase, but to use the one that is designated for in-vehicle usage.

Thirdly, same as solution 103, the present invention represents a solution, wherein the confidential data is initially stored in the memory of mobile computing device only, which is highly beneficial in terms of security. As it is suggested herein, the confidential data is transferred to other devices (e.g., to the in-car computing device) only within the payment transaction, which, in turn, is identified by acknowledging a proximity to the point of sale, as mentioned above. None of the devices, except for the cardholder's mobile device, is required to store this confidential data constantly, e.g., before or after the payment transaction is performed.

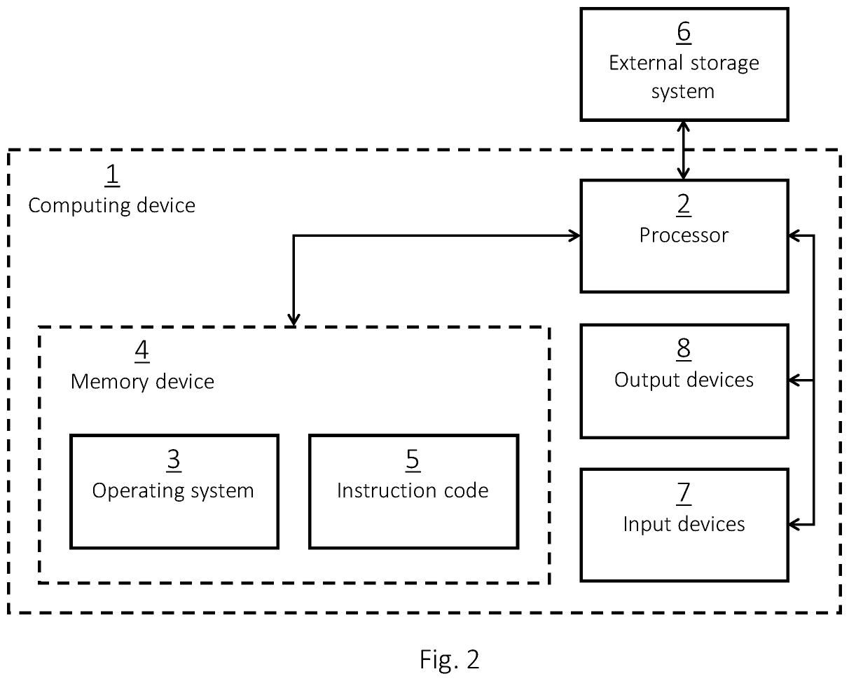

### FIG. 2—The Computing Device in General

Referring now to FIG. 2, a block diagram is represented, depicting a computing device which may be included in the system for performing payment transactions, according to some embodiments.

Computing device 1 may include a processor or controller 2 that may be, for example, a central processing unit (CPU) processor, a chip or any suitable computing or computational device, an operating system 3, a memory device 4, instruction code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to instruction code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory device 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short-term memory unit, a long-term memory unit, or other suitable memory units or storage units. Memory device 4 may be or may include a plurality of possibly different memory units. Memory device 4 may be a computer or processor non-transitory readable medium, or a computer non-transitory storage medium, e.g., a RAM. In one embodiment, a non-transitory storage medium such as memory device 4, a hard disk drive, another storage device, etc. may store instructions or code which when executed by a processor may cause the processor to carry out methods as described herein.

Instruction code 5 may be any executable code, e.g., an application, a program, a process, task, or script. Instruction code 5 may be executed by processor or controller 2 possibly under control of operating system 3. For example, instruction code 5 may be a standalone application or an API module that may be configured to perform different steps of the claimed payment transaction procedure or the authorization procedure, as further described herein. Although, for the sake of clarity, a single item of instruction code 5 is shown in FIG. 1, a system according to some embodiments of the invention may include a plurality of executable code segments or modules similar to instruction code 5 that may be loaded into memory device 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Various types of input and output data may be stored in storage system 6 and may be loaded from storage system 6 into memory device 4 where it may be processed by processor or controller 2. In some embodiments, some of the components shown in FIG. 1 may be omitted. For example, memory device 4 may be a non-volatile memory having the storage capacity of storage system 6. Accordingly, although shown as a separate component, storage system 6 may be embedded or included in memory device 4.

Input devices 7 may be or may include any suitable input devices, components, or systems, e.g., a touchscreen, camera, fingerprint scanner, detachable keyboard or keypad, mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

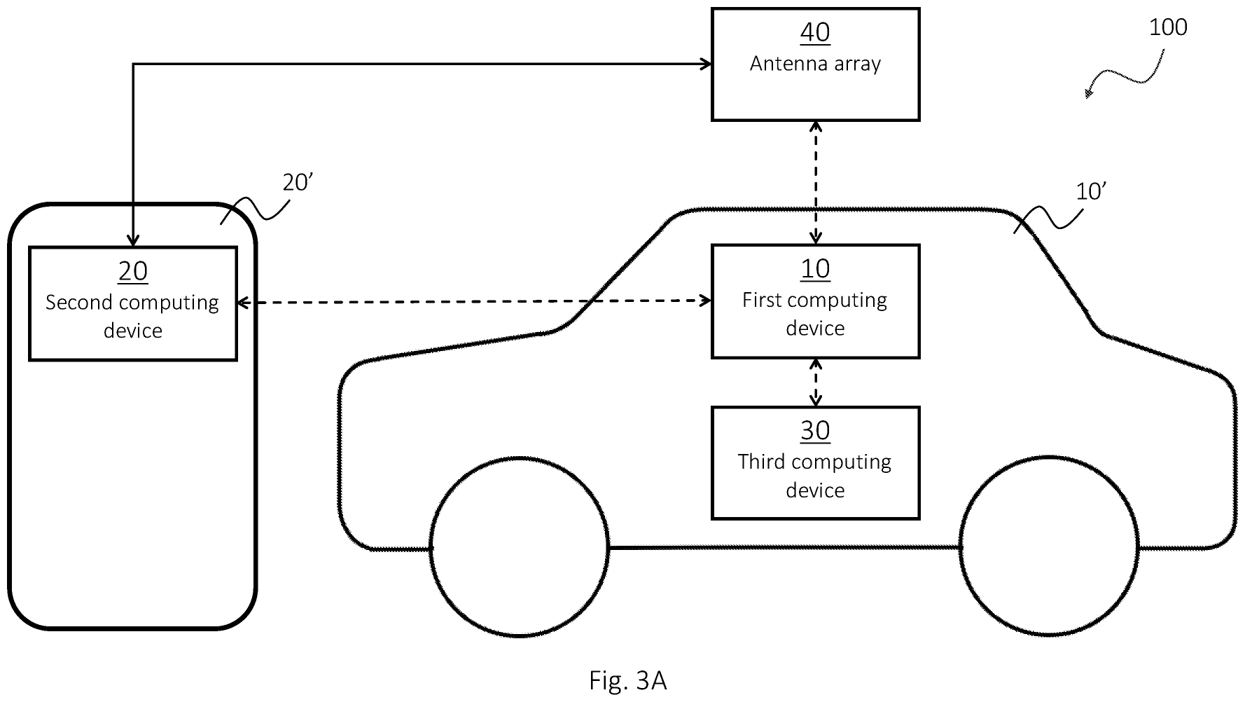

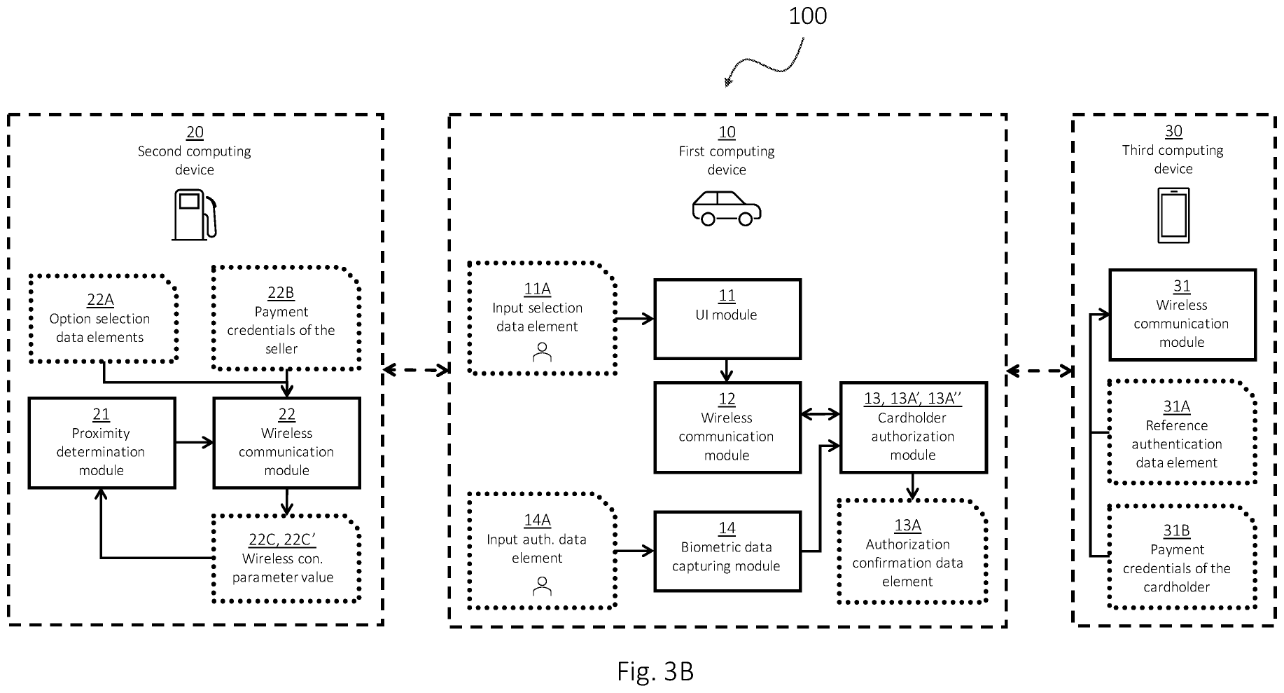

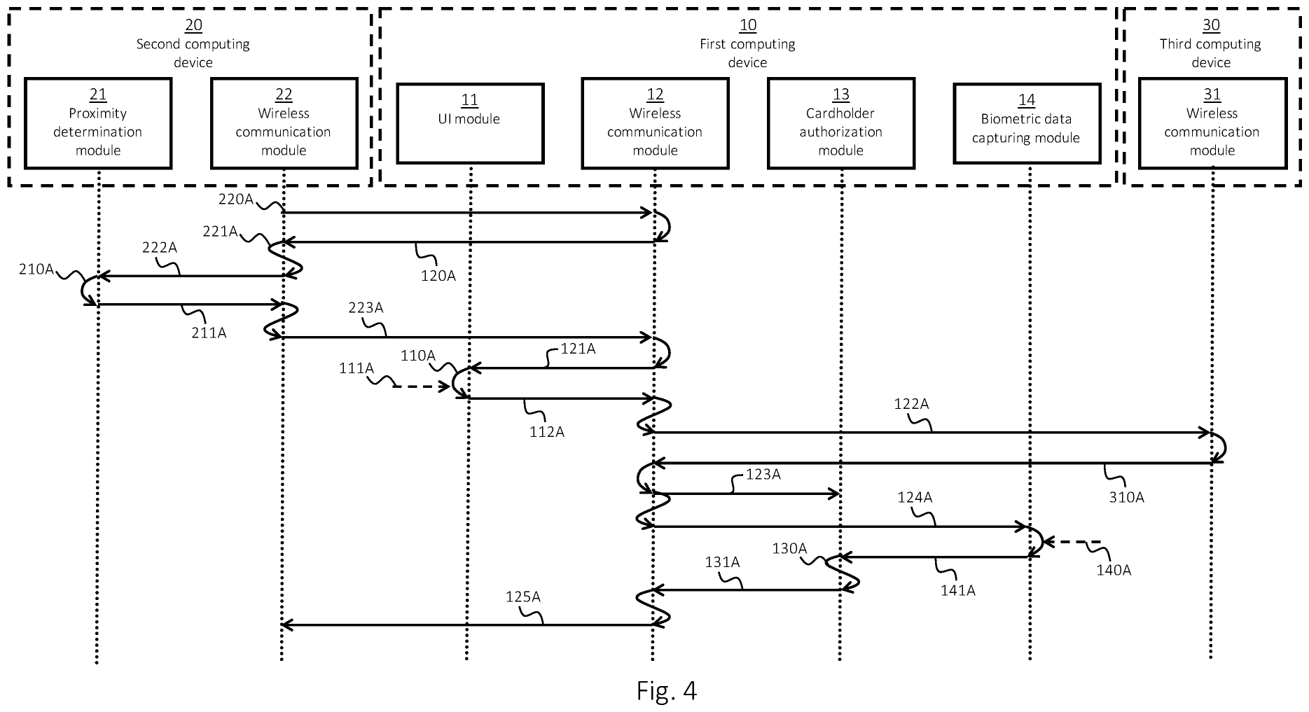

### FIGS. 3A, 3B and 4—System and Interconnection of its Components

Reference is now made to FIGS. 3A, 3B which depict block diagrams, showing hardware and software aspects of system 100 for performing payment transactions, according to some embodiments. Reference is also made to FIG. 4 which depicts a sequence diagram showing performance of a payment transaction by system 100, according to some embodiments.

According to some embodiments of the invention, system 100 may be implemented as a software module, a hardware module, or any combination thereof. For example, system 100 may be or may include one or more computing devices such as element 1 of FIG. 2. Furthermore, system 100 may be adapted to execute one or more modules of instruction code (e.g., element 5 of FIG. 2) to request, receive, analyze, calculate and produce various data.

As further described in detail herein, system 100 may be adapted to execute one or more modules of instruction code (e.g., element 5 of FIG. 2) in order to perform steps of claimed methods of authorizing and performing payment transactions.

As shown in FIGS. 3A, 3B and 4 arrows may represent flow of one or more data elements to and from system 100 and/or among modules or elements of system 100. Some arrows have been omitted in FIGS. 3A, 3B and 4 for the purpose of clarity.

As can be seen in FIG. 3A, in some embodiments, system 100 may include first computing device 10 which is associated with vehicle 10′ (e.g., an in-car computer), second computing device 20 which is associated with point 20′ of sale (e.g., a POS-terminal), and third computing device 30 which is associated with a cardholder (e.g., a personal payment device, e.g., respectively configured smartphone or tablet).

In some embodiments, first computing device 10 may be an in-car computer, which may include, as an input/output device (e.g., input device 7 and output device 8, as shown in FIG. 2), a touchscreen and, optionally, hardware control buttons. First computing device 10 may also include a camera directed to the driver/cardholder and/or a fingerprint scanner.

In some embodiments, second computing device 20 may be a POS-terminal. In some embodiments, second computing device 20 may include a touchscreen, keypad, means of capturing information from payments cards (by contact and/or contactless interfaces) and a network connection to access the payment network. It shall be appreciated that in view of the fact that the present invention may be directed to shifting certain functions (especially user-input-related ones) to the in-car computer (e.g., first computing device 10), in some embodiments, second computing device 20 may not include any input devices like touchscreen, keypad and means of capturing information from payments cards (by contact and/or contactless interfaces). Therefore, in such embodiments, the present invention may further contribute to the improvement of the respective technical field, e.g., by reducing the number of required hardware and software components of payment systems.

In some embodiments, third computing device 30 may be a common mobile device, e.g., a smartphone, smartwatch or tablet.

In some embodiments, point 20′ of sale may be associated with an electrical charging unit or gas unit of a gas station, may be a self-service payment and information electronic terminal, e.g., installed near the drive-thru café, or a terminal installed near the parking entrance.

It also should be appreciated that the technical solution provided herein may be easily integrated into existing systems, since, in some embodiments, it may be deployed on a currently used hardware (e.g., in-car computers, POS-terminals and smartphones) without adding any specific hardware components. The simplicity of integration is traditionally considered one of the most critical aspects of payment systems technology in view of the enormous amount of currently deployed systems worldwide, and the requirement to maintain the support of old solutions together with the new ones.

However, it should be understood that the present invention is not limited by the types of hardware used in the present systems and various types of supplementary hardware may be applied. E.g., in some embodiments, second computing device 20 may include antenna array 40. Antenna array 40 may be positioned above the place where car 10′ is required to be located in order to start the payment transaction. In particular, system 100 may be configured to establish a wireless connection between first computing device 10 and second computing device 20 and to evaluate parameters (e.g., signal strength, AoA, AoD, ToF etc.) of the established wireless connection. When car 10′ is positioned under antenna array 40, a value of specific parameter of the established wireless connection may surpass a predefined threshold value of that parameter, which is used as an indication of the proximity of first computing device 10 to second computing device 20. The aspects of proximity acknowledgement are described in detail with reference to FIGS. 3B and 4 further below.

Such a configuration may further contribute to the improvement of the technical field by increasing the precision of proximity determination (e.g., proximity to point 20′ of sale). This configuration would help to avoid erroneous proximity determination, such as acknowledging the proximity of the car to one point of sale, while it is positioned close to another point of sale nearby (e.g., another charging or gas unit of the same gas station).

### Referring to FIGS. 3B and 4. Details of the System.

Referring now to FIGS. 3B and 4, software aspects of system 100 are described.

In some embodiments, first computing device 10 and second computing device 20 may include wireless communication modules 12 and 22 respectively. Wireless communication modules 12 and 22 may be configured to establish the first wireless connection between computing devices 10 and 20. E.g., communication module 20 may be configured to send, to communication module 10, request 220A to establish connection; and communication module 20 may be configured to send, to communication module 10, response 120A, approving the establishment of the connection. The first wireless connection may be established via antenna array 40 (as shown in FIG. 3A).

Second computing device 20 may further include proximity determination module 21. Communication module 22 may be further configured to determine (e.g., via data processing 221A) values 22C′ of the first wireless connection parameters 22C and transfer (e.g., via data transferring 222A), to proximity determination module 21, said values 22C′ of parameters 22C, after approving the first wireless connection.

Proximity determination module 21 may be further configured to acknowledge (e.g., via data processing 210A) the proximity of first computing device 10 to second computing device 20, provided that value 22C′ of specific parameter 22C surpasses the predefined threshold value of said parameter 22C. Proximity determination module 21 may be further configured to transfer confirmation 211A of the proximity acknowledgement to wireless communication module 22.

Wireless communication module 22 may be further configured to establish, after receiving confirmation 211A, the second wireless connection with wireless communication module 21.

In some embodiments, wireless communication modules 12 and 22 may be configured to establish the first wireless connection and the second wireless connection via a wireless communication protocol selected from a list consisting of: (i) Bluetooth Low Energy (BLE); (ii) Ultra-wideband (UWB); (iii) Wi-Fi; (iv) RFID; and (v) NFC.

In some embodiments, parameter of the first wireless connection is selected from a list consisting of: (i) signal strength; (ii) Angle of Arrival (AoA); (iii) Angle of Departure (AoD); and (iv) Time-of-Flight (ToF).

In some embodiments of the present invention, the first wireless connection may be used only for acknowledging proximity of first computing device 10 to second computing device 20; and the second wireless connection may be used for transferring various payment data (e.g., payment credentials 31B of the cardholder). Accordingly, the first wireless connection and the second wireless connection may use different wireless communication protocols and different security standards.

However, it should be understood that the present invention is not limited in this regard. E.g., in some embodiments, the first and second wireless connections may be performed via the same wireless communication protocol, or they may not be used separately, i.e., the first and second wireless connections may represent the same single connection.

Furthermore, in some alternative embodiments, system 100 may be configured to use other techniques of acknowledging proximity, e.g., not involving the evaluation of wireless connection parameters (e.g., the abovementioned first wireless connection may not be used). E.g., first computing device 10 may be configured to: (i) determine its geolocation via Global Positioning System (GPS); (ii) receive a geolocation of second computing device 20 from a remote server (not shown) (e.g., the remote server may search for the closest point of sale—in this case point 20′ of sale—and transfer its geolocation); (iii) estimate distance from the geolocation of first computing device 10 to the geolocation of second computing device 20; and (iv) acknowledge the proximity of first computing device 10 to second computing device 20, based on the estimated distance.

In yet another alternative embodiment, in order to acknowledge the proximity, parameters of the first wireless connection and GPS data may be used in combination.

It shall be understood that the present invention is not limited in regard of the ways of acknowledging said proximity and other known-in-the-art methods may be applied, e.g., the ones based on infrared or ultrasound proximity detection.

In some embodiments wireless communication module 22 may be further configured to transfer (e.g., via data transferring 223A), upon acknowledging the proximity, to wireless communication module 12, the following: (i) a request to authorize the payment transaction; (ii) a request to receive payment credentials of the cardholder; (iii) option selection data elements 22A, representing optional parameters to be selected by the cardholder.

In some embodiments, data transferring 223A may be performed via the second wireless connection.

In some embodiments, wireless communication module 12 may be further configured to retransfer (e.g., via data transferring 121A) option selection data elements 22A to UI module 11. UI module 11 may be further configured to provide (e.g., via data processing 110A), using user interface (UI) of first computing device 10, UI selection data elements, corresponding to optional parameters to be selected by the cardholder. E.g., said optional parameters may represent types of fuel (if point 20′ of sale is associated with a gas station), food menu positions (if point 20′ of sale is associated with a drive-thru café), special discount offers etc.

In some embodiments, UI module 11 may be further configured to receive (e.g., via data processing 111A), using the UI of first computing device 10, input selection data element 11A, entered by the cardholder, representing selection of at least one of said UI selection data elements. E.g., the cardholder may select the product he wants to purchase, e.g., specific type of fuel, specific food menu position etc., thereby determining the information required for the payment transaction: the type of the product and the corresponding amount to be withdrawn from cardholder's account.

In some alternative embodiments, said optional parameters may be prestored in the memory of first computing device 10 (e.g., within a designated software application installed on first computing device 10, such as gas company application, café application etc.), or downloaded, by first computing device 10 from a remote server, via an internet connection.

In some embodiments, UI module 11 may be further configured to transfer (e.g., via data transferring 112A) input selection data element 11A to wireless communication module 12, e.g., for further retransferring to second computing device 20.

In some embodiments, third computing device 30 (e.g., device, associated with a cardholder, e.g., smartphone or tablet) may include wireless communication module 31. In some embodiments, wireless communication module 12 may be further configured to establish wireless connection with wireless communication module 31. Wireless communication module 12 may be further configured to transfer, to wireless communication module 31 a request 122A to receive (i) reference authentication data element 31A, and (ii) payment credentials 31B of the cardholder.

In some embodiments, wireless communication module 31 may be configured to transfer (e.g., via data transferring 310A), to wireless communication module 21, (i) reference authentication data element 31A, and (ii) payment credentials 31B of the cardholder, in response to request 122A.

In some embodiments, first computing device 10 may further include cardholder authorization module 13. In some embodiments, wireless communication module 21 may be further configured to retransfer (e.g., via data transferring 123A) reference authentication data element 31A to cardholder authorization module 13.

In some embodiments, first computing device 10 may further include biometric data capturing module 14. In some embodiments, wireless communication module 12 may be further configured to transfer, to biometric data capturing module 14, request 124A to receive input authentication data element 14A.

In some embodiments, biometric data capturing module 14 (also referred herein as input module) may be configured to receive (e.g., via data processing 140A) input authentication data element 14A, entered by the cardholder.

It shall be understood that the solution provided by the present invention may include various ways of cardholder identification for the purpose of payment transaction authorization.

E.g., in some embodiments, biometric data capturing module 14 may include a camera (e.g., used as input device 7, shown in FIG. 2). Reference authentication data element 31A and input authentication data element 14A may represent biometric data of the cardholder, e.g., may represent or include an image of a cardholder's face, or any unique identifier computed based on the image of the cardholder's face, e.g., computed using any known types of encoding, converting, hashing etc. Said camera may be installed on a dashboard of the car (vehicle 10′), e.g., may be integrated in the touchscreen of first computing device 10. The term “camera” shall be understood herein in the broadest possible meaning, including any types of devices designated for scanning faces, e.g., a depth camera configured to create a depth map of the face. In such cases, reference authentication data element 31A and input authentication data element 14A may represent a unique identifier calculated based on a depth map.

In some additional or alternative embodiments, biometric data capturing module 14 may include a fingerprint scanner (e.g., used as input device 7, shown in FIG. 2). Reference authentication data element 31A and input authentication data element 14A may accordingly represent or include a scan of a cardholder's fingerprint, or any unique identifier computed based on the scan of a cardholder's fingerprint, e.g., computed using any known types of encoding, converting, hashing etc. Said fingerprint scanner may be installed on a dashboard of the car (vehicle 10′), e.g., may be integrated in the touchscreen of first computing device 10.

In some alternative embodiments (not shown in figures), authentication may be based on a standard passcode checking, and not include biometric identification. I such embodiments, reference authentication data element 31A and input authentication data element 14A may include a numeric or alphanumeric code, and the input module of first computing device 10 may include a touchscreen configured to represent a virtual keyboard for inputting the passcode.

It shall be understood that the term “reference authentication data element” refers herein to the data captured in advance, e.g., when the cardholder configured unlocking functions or digital wallet application of his smartphone (third computing device 30). “Reference” data then securely stored in the memory of third computing device 30 and further may be referred to when needed, e.g., for user authentication. The term “input authentication data element” refers herein to the data analogical to the “reference” one, but captured at the time of the payment transaction in order to confirm that the person trying to perform payment transaction is indeed a cardholder, and thereby authorize or decline the payment transaction accordingly. Said confirmation is done by comparing input authentication data element (e.g., element 14A) with the reference one (e.g., element 31A) and determining their similarity, which may be done, e.g., using known machine-learning and artificial-intelligence techniques. It shall also be understood that, in this context, the term “data element” may refer to an element representing, e.g., a value of a certain parameter (e.g., password) or a file (e.g., image or scan).

In some embodiments, biometric data capturing module 14 may be further configured to transfer (e.g., via data transferring 141A) input authentication data element 14A to cardholder authorization module 13.

In some embodiments, cardholder authorization module 13 may be further configured to compare input authentication data element 14A and reference authentication data element 31A. In particular, cardholder authorization module 13 may be further configured to determine similarity metric value 13A′, representing a degree of similarity between reference authentication data element 31A and input authentication data element 14A.

The term “similarity metric” shall be understood herein in the broadest possible meaning, covering all optional implementations that may be considered as a parameter having a value corresponding to a degree of similarity between two data elements. E.g., in some embodiments, “similarity metric” may be a distance metric (such as Euclidean distance or Hamming distance), same as applied in nearest-neighbor-based machine learning algorithms; or “similarity metric” may be a confidence metric, representing confidence of assigning a specific class to the data element (e.g., assigning to input authentication data element 14A class, representing positive result of the comparison with reference authentication data element 31A); or reconstruction error value, e.g., calculated in result of inferring, on input authentication data element 14A, an autoencoder machine-learning based model pretrained to precisely reconstruct reference authentication data element 31A, etc. It should be understood that the present invention is not limited to the provided examples and any other relevant techniques, e.g., including machine-learning-based and artificial-intelligence-based methods or any other known mathematical methods, either deterministic or statistical, may be applied herein in order to evaluate the similarity between input authentication data element 14A and reference authentication data element 31A.

In some embodiments, cardholder authorization module 13 may be further configured to compare calculated similarity metric value 13A′ with predefined similarity metric threshold value 13A″. When similarity metric value 13A′ surpasses threshold value 13A″, it may be interpreted by cardholder authorization module 13 as an indication of a sufficient similarity of input authentication data element 14A and reference authentication data element 31A. Otherwise, it may be interpreted as an indication of an insufficient similarity of input authentication data element 14A and reference authentication data element 31A. Accordingly, it may indicate whether the identity of the cardholder was verified successfully or not.

In some embodiments, system 100 may be configured so as to prevent transferring of the original version of reference authentication data element 31A to other devices. E.g., third computing device 30 may be further configured to perform one-way encryption procedure (e.g., hashing) on the original version of reference authentication data element 31A, thereby obtaining the encrypted version thereof. Said one-way encryption procedure may be performed using private key, stored in the memory of third computing device 30, or on the remote server. Wireless communication module 31 may be further configured to transfer reference authentication data element 31A in the encrypted version, to wireless communication module 12, which may be configured to retransfer it to cardholder authorization module 13, accordingly. Cardholder authorization module 13 may further store the same private key (symmetric encryption) or be configured to download it from the remote server when needed. Cardholder authorization module 13 may be further configured to perform the same one-way encryption procedure on the original version of input authentication data element 14A, thereby obtaining an encrypted version thereof. Cardholder authorization module 13 may be further configured to compare both authentication data elements 14A and 31A in their encrypted versions (instead of comparing them in their original versions, as described above), and calculate similarity metric value 13A′ based on this comparison, accordingly. Such an embodiment further contributes to the abovementioned improvement of the technical field by additionally enforcing security of confidential data.

It shall be understood, that the technical solution provided by the present invention may involve any other known encryption/decryption algorithms (either symmetric or asymmetric ones) known in the art.

In some embodiments, cardholder authorization module 13 may be configured to authorize the payment transaction (e.g., via data processing 130A), based on similarity metric value 13A′, in particular, may authorize a payment transaction, provided that similarity metric value 13A′ surpasses predefined similarity metric threshold value 13A″. Cardholder authorization module 13 may be further configured to transfer (e.g., via data transferring 131A) authorization confirmation data element 13A to wireless communication module 12.

In some embodiments, wireless communication module 12 may be further configured to retransfer (e.g., via data transferring 125A), to wireless communication module 22, (i) authorization confirmation data element 13A (thereby confirming that the payment transaction has been authorized), (ii) input selection data element 11A, and (iii) payment credentials 31B of the cardholder. Data transferring 125A may be performed via the second wireless connection, described above.

In some embodiments, second computing device 20 may be further configured to settle the payment transaction, provided that the payment transaction is authorized, using input selection data element 11A (which may identify the selected product and thereby the amount to be withdrawn from the cardholder's account) and payment credentials 31B of the cardholder.

Accordingly, in cases when similarity metric value 13A′ does not surpass predefined similarity metric threshold value 13A″, cardholder authorization module 13 may transfer (e.g., via data transferring 131A) an authorization failure data element (not shown in figures), indicating that the cardholder failed to confirm his identity, to wireless communication module 12. Wireless communication module 12 may further retransfer the authorization failure data element to wireless communication module 22, indicating that the payment transaction cannot be further settled.

In some alternative embodiments, settlement of the payment transaction may be performed by first computing device 10. In such embodiments, first computing device 10 may be configured to have an internet connection, e.g., via a broadband cellular network. In such embodiments, wireless communication module 22 may be further configured to transfer, to wireless communication module 12, a seller payment data element, including at least one of: (a) payment credentials 22B of the seller; (b) a Uniform Resource Identifier (URI) link to a payment service of the seller. In such embodiments, first computing device 10 may be further configured to settle the payment transaction using payment credentials 22B of the seller (or said URI-link to the payment service), input selection data element 11A (which may identify the selected product and thereby the amount to be withdrawn from the cardholder's account) and payment credentials 31B of the cardholder.

In some embodiments, system 100 may be further configured to perform additional factors of multi-factor payment transaction authorization.

E.g., in some embodiments, first computing device 10 may store and information about the cardholder's phone number. First computing device 10 may be further configured to transfer, to a remote server associated with the cardholder's bank, a request to send one-time password via an SMS message to cardholder's phone number. Third computing device 30 (which may be a cardholder's smartphone) may be further configured to receive, as an SMS message from the remote server, said one-time password.

In some embodiments, third computing device 30 may be further configured to transfer (automatically, without asking the user to perform any actions with mobile device's UI) said on-time password to first computing device 10 (e.g., from wireless communication module 31 to wireless communication module 12). First computing device 10 may be further configured to transfer the received one-time password to said remote server for confirmation. If said one-time password, received by remote server from first computing device 10, matches the one that was sent to the cardholder's phone number, then this authentication factor may be considered successfully passed.

By the abovementioned mechanism, third computing device 30 may be thus additionally checked for being indeed a device owned by the cardholder. Moreover, by the said mechanism, the whole chain of devices (first computing device 10 and third computing device 30) is additionally checked. Therefore, such an embodiment further contributes to the abovementioned improvement of the technical field of payment systems, by increasing security level.

In the present invention, the procedure of further settling the payment transaction may be performed using common techniques and methods known in the art and is therefore covered by the present invention in the broadest possible meaning.

In some embodiments, payment credentials 31B of the cardholder and payment credentials 22B of the seller may include at least one of: (a) a Primary Account Number (PAN) of the cardholder or the seller accordingly, (b) a payment token of the cardholder or the seller accordingly.

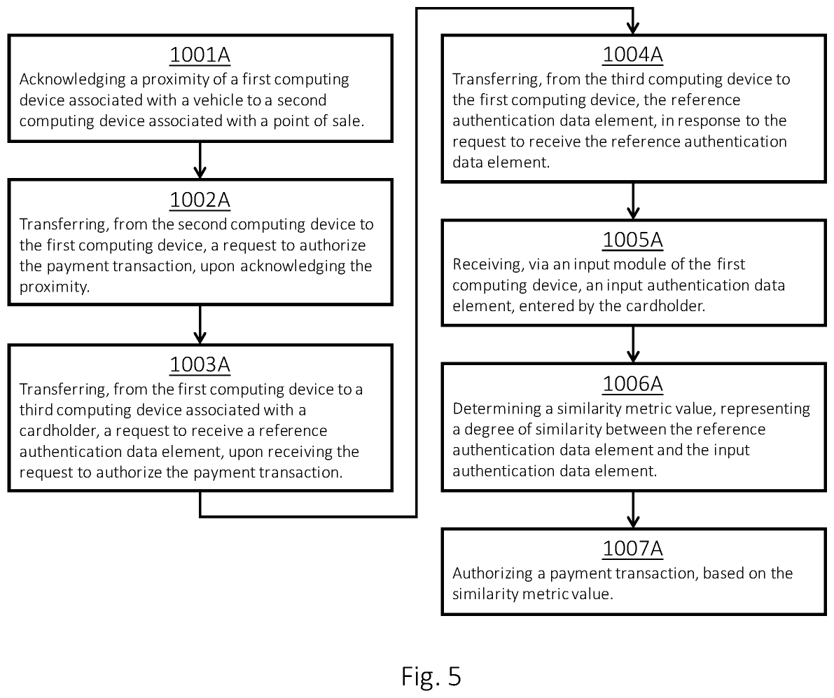

### FIG. 5—The Method

Referring now to FIG. 5, a flow diagram is presented, depicting a method of authorizing payment transactions, according to some embodiments.

As shown in step 1001A, the at least one processor (e.g., processor 2 of FIG. 2) may perform acknowledgement of a proximity of a first computing device (e.g., first computing device 10, as shown in FIGS. 3A, 3B and 4) associated with a vehicle (e.g., vehicle 10′, as shown in FIG. 3A) to a second computing device (e.g., second computing device 20, as shown in FIGS. 3A, 3B and 4) associated with a point of sale (e.g., point 20′ of sale). Step 1001A may be carried out by wireless communication module 12, wireless communication module 22 and proximity determination module 21 (as described with reference to FIGS. 3B and 4).

As shown in step 1002A, the at least one processor (e.g., processor 2 of FIG. 2) may perform transferring, from the second computing device (e.g., second computing device 20, as shown in FIGS. 3A, 3B and 4) to the first computing device (e.g., first computing device 10, as shown in FIGS. 3A, 3B and 4), of a request to authorize the payment transaction, upon acknowledging the proximity. Step 1002A may be carried out by wireless communication module 12 and wireless communication module 22 (as described with reference to FIGS. 3B and 4).

As shown in step 1003A, the at least one processor (e.g., processor 2 of FIG. 2) may perform transferring, from the first computing device (e.g., first computing device 10, as shown in FIGS. 3A, 3B and 4) to a third computing device (e.g., third computing device 30, as shown in FIGS. 3A, 3B and 4) associated with a cardholder, of a request to receive a reference authentication data element (e.g., reference authentication data element 31A, as shown in FIG. 3B), upon receiving the request to authorize the payment transaction. Step 1003A may be carried out by wireless communication module 12 and wireless communication module 31 (as described with reference to FIGS. 3B and 4).

As shown in step 1004A, the at least one processor (e.g., processor 2 of FIG. 2) may perform transferring, from the third computing device (e.g., third computing device 30, as shown in FIGS. 3A, 3B and 4) to the first computing device (e.g., first computing device 10, as shown in FIGS. 3A, 3B and 4), of the reference authentication data element (e.g., reference authentication data element 31A, as shown in FIG. 3B), in response to the request to receive the reference authentication data element. Step 1004A may be carried out by wireless communication module 12 and wireless communication module 31 (as described with reference to FIGS. 3B and 4).

As shown in step 1005A, the at least one processor (e.g., processor 2 of FIG. 2) may perform reception, via an input module (e.g., biometric data capturing module 14, as shown in FIGS. 3B and 4) of the first computing device (e.g., first computing device 10, as shown in FIGS. 3A, 3B and 4), an input authentication data element (e.g., input authentication data element 14A, as shown in FIG. 3B), entered by the cardholder. Step 1005A may be carried out by biometric data capturing module 14 (as described with reference to FIGS. 3B and 4).

As shown in step 1006A, the at least one processor (e.g., processor 2 of FIG. 2) may perform determination of a similarity metric value (e.g., similarity metric value 13A′, as shown in FIGS. 3B), representing a degree of similarity between the reference authentication data element (e.g., reference authentication data element 31A, as shown in FIG. 3B) and the input authentication data element (e.g., input authentication data element 14A, as shown in FIG. 3B). Step 1006A may be carried out by cardholder authorization module 13 (as described with reference to FIGS. 3B and 4).

As shown in step 1007A, the at least one processor (e.g., processor 2 of FIG. 2) may perform authorization of a payment transaction, based on the similarity metric value (e.g., similarity metric value 13A′, as shown in FIGS. 3B). Step 1007A may be carried out by cardholder authorization module 13 (as described with reference to FIGS. 3B and 4).

As can be seen from the provided description, the claimed invention represents the system and method of authorizing and performing payment transactions, which provide an improvement of the technological field of payment systems by increasing security of in-vehicle payments, while maintaining the procedure easy and convenient to the consumer, in particular, by requiring consumer interaction with in-vehicle computer only.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of authorizing payment transactions, by at least one processor, the method comprising:
acknowledging a proximity of a first computing device associated with a vehicle to a second computing device associated with a point of sale;
transferring, from the second computing device to the first computing device, a request to authorize the payment transaction, upon acknowledging the proximity;
transferring, from the first computing device to a third computing device associated with a cardholder, a request to receive a reference authentication data element, upon receiving the request to authorize the payment transaction;
transferring, from the third computing device to the first computing device, the reference authentication data element, in response to the request to receive the reference authentication data element;
receiving, via an input module of the first computing device, an input authentication data element, entered by the cardholder;
determining a similarity metric value, representing a degree of similarity between the reference authentication data element and the input authentication data element; and
authorizing a payment transaction, based on the similarity metric value.

2. The method of claim 1, wherein the input module comprises a biometric data capturing module, and wherein the reference authentication data element and the input authentication data element represent biometric data of the cardholder.

3. The method of claim 2, wherein the biometric data capturing module comprises a camera; and wherein the reference authentication data element and the input authentication data element comprise an image of a cardholder's face.

4. The method of claim 2, wherein the biometric data capturing module comprises a fingerprint scanner; and wherein the reference authentication data element and the input authentication data element comprise a scan of a cardholder's fingerprint.

5. The method of claim 1, wherein the input module comprises a touchscreen configured to represent a virtual keyboard; and wherein the reference authentication data element and the input authentication data element comprise a numeric or alphanumeric code.

6. The method of claim 1, wherein acknowledging the proximity of the first computing device to the second computing device comprises:
establishing a first wireless connection between the first computing device and the second computing device;
determining a value of at least one parameter of the first wireless connection; and
acknowledging the proximity of the first computing device to the second computing device, provided that the value of the at least one parameter surpasses a predefined threshold value of the at least one parameter.

7. The method according to claim 6, wherein the second computing device comprises an antenna array and the at least one parameter of the first wireless connection is selected from a list consisting of: (i) signal strength; (ii) Angle of Arrival (AoA); (iii) Angle of Departure (AoD); and (iv) Time-of-Flight (ToF).

8. The method according claim 1, the method further comprising
establishing a second wireless connection between the first computing device and the second computing device, provided that the proximity is acknowledged;
wherein said transferring, from the second computing device to the first computing device, the request to authorize the payment transaction, is performed via the second wireless connection, and
wherein the method further comprises:
transferring, from the first computing device to the second computing device via the second wireless connection, an authorization confirmation data element, confirming that the payment transaction has been authorized.

9. The method according to claim 8, wherein the first wireless connection and/or the second wireless connection is performed via a wireless communication protocol selected from a list consisting of: (i) Bluetooth Low Energy (BLE); (ii) Ultra-wideband (UWB); (iii) Wi-Fi; (iv) RFID; and (v) NFC.

10. The method of claim 1, wherein acknowledging the proximity of the first computing device to the second computing device comprises:
determining a geolocation of the first computing device via Global Positioning System (GPS);
estimating distance from the geolocation of the first computing device to a geolocation of the second computing device;
acknowledging the proximity of the first computing device to the second computing device, based on the estimated distance.

11. The method of claim 1, wherein authorizing a payment transaction, based on the similarity metric value, comprises authorizing a payment transaction, provided that the similarity metric value surpasses a predefined similarity metric threshold value.

12. A method of performing payment transactions, by at least one processor, the method comprising:
acknowledging a proximity of a first computing device associated with a vehicle to a second computing device associated with a point of sale;
transferring, from the second computing device to the first computing device, a request to authorize the payment transaction, upon acknowledging the proximity;
transferring, from the first computing device to a third computing device associated with a cardholder, a request to receive a reference authentication data element, upon receiving the request to authorize the payment transaction;
transferring, from the third computing device to the first computing device, the reference authentication data element, in response to the request to receive the reference authentication data element;
receiving, via an input module of the first computing device, an input authentication data element, entered by the cardholder;
determining a similarity metric value, representing a degree of similarity between the reference authentication data element and the input authentication data element;
authorizing a payment transaction, based on the similarity metric value; and
settling the payment transaction, provided that the payment transaction is authorized.

13. The method of claim 12, further comprising,
transferring, from the second computing device to the first computing device, request to receive payment credentials of the cardholder;
transferring, from the first computing device to the second computing device, payment credentials of the cardholder, in response to the request to receive the payment credentials of the cardholder, provided that the payment transaction is authorized; and
wherein settling the payment transaction is performed by the second computing device, using the payment credentials of the cardholder.

14. The method of claim 13, further comprising
retransferring, from the first computing device to the third computing device, a request to receive the payment credentials of the cardholder;
transferring, from the third computing device to the first computing device, the payment credentials of the cardholder, in response to the request to receive the payment credentials of the cardholder.

15. The method of claim 13, further comprising
transferring, from the first computing device to the third computing device, a request to receive the payment credentials of the cardholder;
transferring, from the third computing device to the first computing device, the payment credentials of the cardholder, in response to the request to receive the payment credentials of the cardholder;
wherein settling the payment transaction is performed by the first computing device, using the payment credentials of the cardholder.

16. The method of claim 15, further comprising
transferring from the second computing device to the first computing device, a seller payment data element, comprising at least one of: (a) a payment credentials of a seller; (b) a Uniform Resource Identifier (URI) link to a payment service of a seller; and
wherein settling the payment transaction is further performed using the seller payment data element.

17. The method of claim 16, further comprising
providing, via a user interface (UI) of the first computing device, UI selection data elements, corresponding to optional parameters to be selected by the cardholder;
receiving, via the UI of the first computing device, an input selection data element, entered by the cardholder, representing selection of at least one of said UI selection data elements; and
wherein settling the payment transaction is further performed based on the input selection data element.

18. The method of claim 16, further comprising
transferring, from the second computing device to the first computing device, an option selection data element, representing said optional parameters; and wherein
providing, via the UI of the first computing device, UI selection data elements, is performed based on the option selection data element.

19. The method according to claim 13, wherein the payment credentials of the cardholder or the payment credentials of the seller comprise at least one of: (a) a Primary Account Number (PAN) of the cardholder or the seller accordingly, (b) a payment token of the cardholder or the seller accordingly.

20. A system for performing payment transactions, the system comprising: a non-transitory memory device, wherein modules of instruction code are stored, and at least one processor associated with the memory device, and configured to execute the modules of instruction code, whereupon execution of said modules of instruction code, the at least one processor is configured to:
acknowledge a proximity of a first computing device associated with a vehicle to a second computing device associated with a point of sale;
transfer, from the second computing device to the first computing device, a request to authorize the payment transaction, upon acknowledging the proximity;
transfer, from the first computing device to a third computing device associated with a cardholder, a request to receive a reference authentication data element, upon receiving the request to authorize the payment transaction;
transfer, from the third computing device to the first computing device, the reference authentication data element, in response to the request to receive the reference authentication data element;
receive, via an input module of the first computing device, an input authentication data element, entered by the cardholder;
determine a similarity metric value, representing a degree of similarity between the reference authentication data element and the input authentication data element;
authorize a payment transaction, based on the similarity metric value; and
settle the payment transaction, provided that the payment transaction is authorized.
